(19) United States
(12) Patent Application Publication
(10) Pub. No.: US 2026/0184603 A1
(43) Pub. Date: Jul. 2, 2026

(54) BLOCKCHAIN-VALIDATED CONTROL SYSTEM FOR AUTOMATED WATER TREATMENT OPERATIONS

(71) Applicant: ORIGINCLEAR, INC., Clearwater, FL (US)

(72) Inventors: T. Riggs ECKELBERRY, Clearwater, FL (US); Kenneth BERENGER, JR., Murrysville, PA (US)

(21) Appl. No.: 19/544,387

(22) Filed: Feb. 19, 2026

Related U.S. Application Data
(63) Continuation-in-part of application No. 18/863,008.

(51) Int. Cl. C02F 1/00; H04L 9/00

(52) U.S. Cl. CPC C02F 1/008; H04L 9/50; C02F 2209/001; C02F 2209/008; C02F 2209/40

(57) ABSTRACT

A water treatment system includes a water treatment station having a water input and a water output, an input sensor measuring an input flow, an output sensor measuring an output flow, a quality sensor measuring water quality, an actuator to adjust operating parameter and a connection through a network. A blockchain subsystem includes a plurality of user terminals, a ledger for registering peer to peer transactions and a program enabling peer to peer transactions between the terminals by exchanging tokens through a consensus mechanism. The remote computer receives information issued by the sensors and generates control-authorization transaction having the actuator-control value and quantity of digital tokens representing a quantified operational performance of the water treatment station based on the received information. In response to the validation of the control-authorization transaction, the computer transmits a control signal to the water treatment station to adjust the actuator according to the actuator-control value.

### RELATED APPLICATIONS

This application is a continuation-in-part application of U.S. application Ser. No. 18/863,008 filed Nov. 5, 2024, which is a § 371 application of PCT/US2022/027917 filed May 5, 2022, each of which is incorporated herein by reference in its entirety.

### TECHNICAL FIELD

The claimed invention relates to automated and networked water treatment control system. More particularly, the claimed invention relates to a computer-implemented water treatment system that improves the secure, reliable, and verifiable operation of physical water treatment equipment using a distributed ledger and consensus-based authorization to control electronically controllable actuators.

### BACKGROUND OF THE INVENTION

Clean water is becoming a scarce resource in some areas/states, because of drought, over exploitation of aquifers e.g. for farming, uneven rain precipitation connected to global warming side effects, population growth, industrial pollution.

Access to clean water is vital to the public health, welfare and economy.

In this framework preserving the resource by avoiding the rejection of polluted water is of primary importance.

Most of the water used in human activities, whether industrial, personal or agricultural requires treatment that may consist in pre-treatment or purification, effluent or post treatment, and process reuse or recycling, or a combination thereof.

Water treatment installations are expensive investments, that last for decades.

Purification takes a water from a source that may be as for instances the environment or municipal water and aims at making it suitable for its intended use. Other steps such as mineralization may occur.

Effluent treatment aims at making the water or a mix of water and contaminants suitable for its release after use in, e.g., the environment or a municipal sewer.

Process reuse or recycling makes use water after a first use to make it suitable for up to multiple reuses.

Depending on the scale of observation, like the scale of a specific process, of a household, of a plant, of a city, of a country each type of water treatment may be considered of any of the above 3 and actually may be a combination of the 3 depending on the observation point.

Ultimately, water is taken from the environment and reintroduced in the environment. But even when considering this overall scheme, City A may pump water in or from an aquifer, part of this water is used, e.g., by citizens and released as wastewater to the sewer, where it is treated before being released in the environment e.g. in a river. City B pumps water from the aforesaid river and purifies it before dispatching it to its citizens etc.

What is called “water consumption” is actually a cycle. In such a cycle virtuous consumption is when water spoiled by human activity, whether industrial or individual, is released to the environment as clean as it was extracted from this environment.

Harmful consumption is when water is released untreated in the environment.

The latter may have deleterious effects and may affect a much higher quantity of water than what was actually released, as well as affecting areas remote from the spill. As a for instance, on Jan. 30, 2000, a gold and silver extracting plant in Bala Mare (Romania) accidentally released polluted water containing sodium cyanide and other substances in a nearby river. The polluted water travelled during 14 days and over 800 km in various rivers down to the Danube River and the Black Sea, killing all water life over its travel and making the water unsuitable for common usage for months in neighbouring countries.

Without going that extreme, poor effluent treatment by one user may significantly affect the cost of the purification by another.

These issues are commonly addressed through regulations. However, regulations do not provide incentives to go beyond and are based on a compromise that may not be suitable for a specific case or a specific community. In the example of Cities A, B and C pumping their water consumption and releasing their wastewater in the same river, City C that is downstream of City A and City B, may experience higher pre-treatment and post-treatment costs than Cities A and B even if the latter strictly respected the regulations.

Moreover, water treatment emits CO₂ mainly from operational energy use. Tightening the regulations in order to improve water quality, may result in an increase of carbon emissions connected with water treatment. Although, some type of treatment may be less emissive than others, as mentioned above, those installations are expensive and long lasting. There are currently no incentives or mechanism for a company to change or upgrade a water treatment installation in order to reduce carbon emissions, liable to result in a long enough lasting payback to make such an upgrade economically sound. As a result, the cost of such an upgrade ends up being paid by the end user, although beneficial on a world scale level.

To give an order of magnitude, in a country like England, water treatment accounts for 11 million metric tons of CO₂ emissions per year. In a country like France water treatment accounts for 2% of the overall GHG emissions.

Automated water treatment systems commonly employ computerized control platforms to regulate physical processes such as fluid flow, pressure, chemical dosing, filtration, and disinfection. These platforms typically rely on centralized supervisory control and data acquisition (SCADA) architectures in which sensor data are collected, control decisions are computed, and actuator commands are issued within a trusted computing environment.

Such centralized architectures present several technical limitations. First, they create single points of failure that can compromise operational reliability. Second, they are susceptible to unauthorized access, spoofed commands, or data tampering, which can result in improper actuator operation and degraded water quality. Third, conventional systems generally lack a tamper-resistant mechanism for independently verifying that a particular actuator adjustment was authorized, justified by measured conditions, and executed as intended.

At the same time, modern water treatment deployments increasingly operate in distributed, remote, or performance-based environments, including decentralized treatment units, mobile treatment systems, and outcome-based service models. In these environments, there is a technical need for machine-enforced control authorization that does not rely solely on centralized trust, human intervention, or after-the-fact audits.

Accordingly, there is a need for a water treatment control architecture that improves the technical operation of physical treatment equipment by providing cryptographically verifiable, consensus-based authorization of actuator adjustments, thereby enhancing cybersecurity, reliability, and traceability at the level of machine control.

### OBJECT AND SUMMARY OF THE INVENTION

The invention pertains to a system and a method enabling traceability of an individual water quantity (e.g., a gallon) along a single or chained water treatment stations of various types.

To this end, the invention uses blockchain technology as well as smart contracts to follow, in a virtual space, the trading involved in a water treatment system and to trigger selected actions based on token exchanges and rules implemented in smart contracts among the users and/or between the water treatment stations themselves.

Throughout the text “water treatment” shall be understood in a broad sense, and, although mostly concerned by the removal of contaminants from water, extends to any operation in a water distribution system including simple pumping, conveyance and discharging.

The person skilled in the art understands that although the invention is disclosed in the framework of water treatment, it may apply to other resources sharing common characteristics without departing from the invention. Nonlimiting examples of resources or treatments that may use the system and the method of the invention or part of, are forestry, halieutics resources (aquaculture), municipal waste, GHGs, etc.

From an overall point of view, the invention aims at managing streams and stock of a resource that cannot be, or hardly be, appropriated, sometimes referred to as common goods, or involving natural processes beyond human capabilities for their renewal, their creation or their purification. However, in some embodiments, the invention may be limited to the management of streams or to the management of the stock.

The claimed invention provides a computer-implemented water treatment system that integrates sensor-driven control algorithms with a distributed ledger system to produce a technical improvement in the control of physical water treatment equipment.

In accordance with an embodiment of the claimed invention, sensor measurements of input flow, output flow, and water quality are transmitted to a remote computing system that computes an operating control value for a water treatment station. Rather than directly issuing a control command, the remote computing system generates a control transaction that includes both the operating control value and a quantified representation of treatment performance. The control transaction is submitted to a blockchain system, where validation by a consensus program functions as a machine-enforced authorization condition for actuator adjustment.

Only after successful validation of the control transaction is a control signal transmitted to the water treatment station to physically adjust one or more electronically controllable actuators. This architecture couples distributed ledger validation directly to the operation of physical hardware, thereby preventing unauthorized or unverified control actions and creating an immutable, technical audit trail of control decisions.

Unlike abstract data processing or financial transaction systems, the claimed invention is directed to a specific improvement in the way computers, networks, and distributed ledgers are used to control real-world water treatment machinery.

In accordance with an exemplary embodiment of the claimed invention, a computer-implemented water treatment control system is provided that integrates a blockchain-based authorization subsystem into the actuator control loop. Sensor data from a water treatment station is transmitted to a remote computer, which computes actuator control values using a control algorithm. Before any actuator adjustment is executed, the remote computer generates a control-authorization transaction containing the actuator control value and a quantity of digital tokens representing operational performance. The transaction is submitted to a blockchain system, where a consensus program validates it. Only upon validation does the system transmit a control signal to adjust the actuator.

This architecture provides a machine-enforced, tamper-resistant authorization layer that improves cybersecurity, reliability, and traceability of automated water treatment operations.

More specifically, the computer-implemented water treatment control system comprises a water treatment station comprising a water input, a water output, at least one electronically controllable actuator configured to adjust an operating parameter of the water treatment station, and an energy source supplying power to the actuator. An input flow sensor is configured to measure an input flow rate at the water input and to generate input-flow information. An output flow sensor is configured to measure an output flow rate at the water output and to generate output-flow information. A water-quality sensor is configured to measure at least one water-quality parameter at the water output and to generate quality information. A network interface is configured to transmit the input-flow information, the output-flow information, and the quality information to a remote computer over a communications network. A blockchain-based authorization subsystem comprises a plurality of user-operated terminals; a plurality of digital tokens; a distributed ledger stored in non-transitory memory and configured to record peer-to-peer transactions between the terminals; and a consensus program executed by a plurality of processors to validate the peer-to-peer transactions and append validated transactions to the distributed ledger. The remote computer comprises at least one processor and a non-transitory memory storing instructions which, when executed, cause the processor to: receive, via the network interface, the input-flow information, the output-flow information, and the quality information; compute, using a control algorithm, at least one actuator-control value for the water treatment station based on the input-flow information, the output-flow information, and the quality information; and generate a control-authorization transaction. The control-authorization transaction comprises the actuator-control value and a quantity of the digital tokens representing a quantified operational performance of the water treatment station during a preceding treatment interval. The control-authorization transaction is submitted to the blockchain-based authorization subsystem for validation and recording in the distributed ledger. In response to validation of the control-authorization transaction by the consensus program, the remoter computer transmits a control signal to the water treatment station to adjust said at least one electronically controllable actuator according to the actuator-control value. The validation of the control-authorization transaction by the consensus program forms a machine-enforced, tamper-resistant authorization layer interposed between the control algorithm and the actuator. The actuator adjustments are executable only upon successful blockchain validation, thereby providing a technical improvement in cybersecurity, operational reliability, and traceability of automated water-treatment control loops.

In accordance with an exemplary embodiment of the claimed invention, the aforesaid electronically controllable actuator comprises a valve actuator, pump actuator, chemical-dosing actuator, or aeration actuator configured to physically modify water-treatment conditions.

In accordance with an exemplary embodiment of the claimed invention, the aforesaid electronically controllable actuator comprises a variable-speed pump, a chemical-dosing valve, or an aeration controller, and wherein the actuator-control value specifies a continuous-valued adjustment rather than a binary on/off command.

In accordance with an exemplary embodiment of the claimed invention, the aforesaid control algorithm executed by the remote computer comprises a predictive model configured to estimate a future water-quality parameter based on historical sensor data, and wherein the actuator-control value is computed to preemptively correct a predicted deviation from a regulatory threshold.

In accordance with an exemplary embodiment of the claimed invention, the aforesaid blockchain subsystem is configured to reject control transactions that fail validation, thereby preventing unauthorized actuator adjustments and improving cybersecurity of the water-treatment station.

In accordance with an exemplary embodiment of the claimed invention, the control-authorization transaction further comprises a cryptographic hash of the input-flow information, output-flow information, and quality information, the hash binding the actuator-control value to the sensor data used to generate it.

In accordance with an exemplary embodiment of the claimed invention, the aforesaid remote computer is further configured to generate a rollback-authorization transaction when the quality information indicates a fault condition, the rollback-authorization transaction instructing the actuator to revert to a previously validated control state.

In accordance with an exemplary embodiment of the claimed invention, the aforesaid distributed ledger stores a chronological sequence of actuator-control values, sensor data hashes, and token quantities, thereby enabling post-event forensic reconstruction of control-loop behavior.

In accordance with an exemplary embodiment of the claimed invention, the aforesaid consensus program rejects control-authorization transactions that exceed a predefined rate-of-change threshold for the actuator-control value, thereby preventing abrupt or unsafe actuator movements.

In accordance with an exemplary embodiment of the claimed invention, the aforesaid remote computer is further configured to compute a confidence score for the actuator-control value, and wherein the control-authorization transaction includes the confidence score as an additional parameter evaluated by the consensus program.

In accordance with an exemplary embodiment of the claimed invention, the aforesaid blockchain-based authorization subsystem is further configured to maintain separate permission tiers for human operators and automated control algorithms, and wherein only transactions generated by the remote computer require consensus validation.

In accordance with an exemplary embodiment of the claimed invention, the aforesaid water-quality sensor comprises a multi-parameter probe configured to measure at least two of: pH, turbidity, dissolved oxygen, oxidation-reduction potential, conductivity, or residual disinfectant concentration.

In accordance with an exemplary embodiment of the claimed invention, the aforesaid remote computer is further configured to generate a diagnostic transaction when the input-flow information and output-flow information differ by more than a threshold amount, the diagnostic transaction being recorded in the distributed ledger independently of actuator control.

In accordance with an exemplary embodiment of the claimed invention, the aforesaid distributed ledger stores a chronological sequence of validated control transactions, enabling traceability of actuator adjustments for regulatory compliance and operational auditing.

In accordance with an exemplary embodiment of the claimed invention, the aforesaid consensus program comprises a proof-of-authority, proof-of-stake, or Byzantine-fault-tolerant consensus mechanism executed by a plurality of processors to provide tamper-resistant validation.

In accordance with an exemplary embodiment of the claimed invention, the aforesaid consensus program comprises a Byzantine-fault-tolerant protocol executed across geographically distributed processors to ensure that actuator adjustments cannot be authorized by a single compromised node.

In accordance with an exemplary embodiment of the claimed invention, the aforesaid digital tokens are algorithmically minted or burned based on a performance metric comprising at least one of: (i) energy consumption per unit of treated water, (ii) deviation from a target water-quality parameter, or (iii) hydraulic efficiency of the water treatment station.

In accordance with an exemplary embodiment of the claimed invention, the aforesaid remote computer is further configured to delay transmission of the control signal until a minimum quorum of consensus nodes validates the control-authorization transaction, thereby enforcing a hardware-independent safety interlock.

In accordance with an exemplary embodiment of the claimed invention, the aforesaid network interface is further configured to encrypt the input-flow information, output-flow information, and quality information using a public key associated with the blockchain-based authorization subsystem.

In accordance with an exemplary embodiment of the claimed invention, the aforesaid quality sensor comprises at least one of: a turbidity sensor, pH sensor, conductivity sensor, dissolved-oxygen sensor, oxidation-reduction potential sensor, or residual-chlorine sensor.

In accordance with an exemplary embodiment of the claimed invention, the aforesaid remote computer is further configured to generate a diagnostic alert when the operating control value exceeds a predefined threshold, and to include the alert in the control transaction submitted to the blockchain subsystem.

In accordance with an exemplary embodiment of the claimed invention, the aforesaid network interface comprises a secure communication module implementing encrypted data transmission to prevent interception or modification of sensor information or control signals.

In accordance with an exemplary embodiment of the claimed invention, the quantified treatment performance represented by the tokens is computed based on at least one of: energy consumption, contaminant removal efficiency, flow-rate stability, or compliance with water-quality standards.

In accordance with an exemplary embodiment of the claimed invention, a computer-implemented method for secure and autonomous control of a water-treatment station is provided. The method is executed by at least one processor of a remote computer and comprises receiving, via a communications network, input-flow information from an input flow sensor, output-flow information from an output-flow sensor, and quality information from a water-quality sensor of a water-treatment station. The water-treatment station comprises at least one electronically controllable actuator. The remote computer processes the input-flow information, the output-flow information, and the quality information using a control algorithm to compute at least one actuator-control value configured to adjust an operating parameter of the water-treatment station. The remote computer generates a control-authorization transaction comprising the actuator-control value and a quantity of digital tokens representing a quantified operational performance of the water-treatment station during a preceding treatment interval. The control-authorization transaction is submitted to a blockchain-based authorization subsystem comprising a plurality of user-operated terminals, a plurality of digital tokens, a distributed ledger stored in non-transitory memory, and a consensus program executed by a plurality of processors. The consensus program executes a validation procedure, which comprises cryptographically verifying the integrity of the control-authorization transaction, confirming token-based authorization conditions associated with the actuator-control value, and appending the validated control-authorization transaction to the distributed ledger. Only in response to successful validation of the control-authorization transaction, the remote computer transmits a control signal to the water-treatment station to adjust the electronically controllable actuator according to the actuator-control value. A machine-implemented, tamper-resistant authorization layer interposed between the control algorithm and the electronically controllable actuator is enforced through the blockchain-based validation procedure. Thereby, this prevents execution of actuator adjustments lacking validated authorization, improves cybersecurity by eliminating single-point-of-failure control pathways, increases operational reliability through consensus-based gating of actuator commands, and provides immutable traceability of control-loop decisions within the distributed ledger.

In accordance with an exemplary embodiment of the claimed invention, a non-transitory computer-readable medium storing instructions that, when executed by at least one processor of a remote computer, cause the processor to perform the aforesaid method for secure and autonomous control of a water-treatment station.

In accordance with an exemplary embodiment of the claimed invention, the actuator-control value further comprises applying a predictive model trained on historical flow-rate and water-quality data to forecast a future operating condition of the water-treatment station.

In accordance with an exemplary embodiment of the claimed invention, the consensus program implements a proof-of-authority consensus mechanism executed by authenticated processors associated with the user-operated terminals.

In accordance with an exemplary embodiment of the claimed invention, the control signal is encrypted using a session-specific symmetric key generated after validation of the control-authorization transaction.

In accordance with an exemplary embodiment of the claimed invention, the quantity of digital tokens included in the control-authorization transaction is computed based on at least one of: energy consumption, treatment efficiency, contaminant-removal rate, or compliance with regulatory water-quality thresholds.

In accordance with an exemplary embodiment of the claimed invention, the actuator-control value comprises a multi-parameter control vector including at least one of: flow-rate adjustment, chemical-dosing rate, aeration intensity, or filtration-cycle duration.

In accordance with an exemplary embodiment of the claimed invention, the remote computer adjusts a token-issuance rate based on a rolling average of water-treatment performance metrics.

In accordance with an exemplary embodiment of the claimed invention, the digital tokens are non-transferable performance tokens usable exclusively for authorizing actuator-control values.

In accordance with an exemplary embodiment of the claimed invention, the remote computer is configured to retry submission of the control-authorization transaction upon detection of a failed or incomplete consensus cycle.

In accordance with an exemplary embodiment of the claimed invention, the remote computer stores each actuator-control value and corresponding blockchain validation result in a local audit log separate from the distributed ledger.

In accordance with an exemplary embodiment of the claimed invention, the sensor information received is buffered and packet-ordered to compensate for variable network latency.

In accordance with an exemplary embodiment of the claimed invention, wherein the communications network comprises at least one of: a cellular network, a low-power wide-area network (LPWAN), a satellite link, or a wired Ethernet connection.

Thus, each gallon (or any other quantity) of water treated by the water treatment station is associated to a token that enables trading between the terminals connected to the blockchain.

The invention is advantageously implemented according to the following nonlimiting specific embodiments, that can be considered individually or according to any technically operative combination thereof.

Advantageously, the terminals connected to the blockchain between which transactions may occur comprise terminals owned by stakeholders of a water treatment system.

According to an embodiment, the system comprises tokens of the Nonfungible Token (NFT) type. NFTs are attributed to a specific type of water gallons giving them a warranty of origin. Such a warranty of origin may be connected to a geographical location, a particular type of treatment, a specific purity or pollution index, i.e., from an overall point of view is reflecting a quantity or specific state of the water in terms of whether good or bad quality, depending on the foreseen implementation; potentially related to the cost of the original investment in the water treatment system and bearing pro rata income therefrom. An NFT can be minute (i.e. representing as little as one gallon with no subdivision) or very large, with the ability to break off fractions which will be in themselves unique.

According to embodiments, the water treatment station may be of the fixed type, e.g., a water treatment plant or of the mobile type, e.g., a water treatment trailer or container.

Advantageously, the water treatment station comprises a geolocation device and the geolocation information is transmitted to the computer along with the information issued by the sensors.

According to an embodiment, the system of the invention comprises a quality input sensor or a quality output sensor measuring parameters characterizing the water, the aforesaid parameters are transmitted to the computer.

In such an embodiment, the quality input sensor or the quality output sensor are measuring at least one parameter among:
temperature,
Ph,
Calcium content,
Nitrates content,
Chlorine content,
heavy metal content,
turbidity and Total Suspended Solids,
Total Dissolved Solids,
Biological Oxygen Demand,
Chemical Oxygen Demand,
Specific molecules such as arsenic or polyfluoroalkyl substances (PFAS),
microplastic content
without this list being limiting.

Depending on the application and on the parameter, these measurements may be carried out “on the fly” or on a periodical basis. In this latter case, they may be associated with a set of tokens that are associated to a given quantity of treated water either before or after the measurement, and they may be tied to the pro rata revenue share associated with that quantity in such a way that the NFT bearer inherently receives the pro rata revenue.

All this information is recorded in association with the token.

Advantageously, each recorded association with a token is date-stamped by the computer.

According to an embodiment, the water treatment station also comprises an energy consumption sensor and transmit this information to the computer along with the type of energy source.

Accordingly, eventually by combining this information with the geolocation information and the date information, the carbon footprint of the corresponding treatment is determined and recorded in association with the token.

The way the tokens are associated to a given quantity and quality of water as well as the type of token, whether utility or NFT, and the way the transactions involving tokens are carried out between the stakeholders are defined in smart contracts, the corpus of which ruling the blockchain being also known as “lex cryptographica”.

To this end, the system of the invention comprises a program known as a smart contract that rules the conditions of a transaction between two or more terminals connected to the blockchain as well as the conditions to trigger such a transaction.

A transaction may consist in an exchange where a first given amount of tokens of defined type are credited to the benefit of one stakeholder and a second given amount of token of a defined type are debited at the expense of another stakeholder, or may result in a destruction of tokens, or may consist in the substitution of a certain amount of tokens of one category with another amount of tokens of another category, whether each amount belongs to the same stakeholder or to different stakeholders, or combination thereof. A token may also be switched to an “off state” at the end of life of the water treatment system it represents.

The invention also pertains to a method implementing the water treatment system of the claimed invention. A terminal A and a terminal B, respectively, held by stakeholder A and stakeholder B are connected to the blockchain. A smart contract defines the cost in tokens of a given transaction between terminal A and terminal B. The transaction being triggered by an event defined in the smart contract. The method comprising the steps of:
sending a request via terminal A triggering the event;
upon receipt by terminal B, validating the transaction through the consensus mechanism;
debiting or crediting tokens from terminal A to terminal B according to the terms and conditions of the smart contracts; and
recording the transaction in the ledger.

According to an embodiment, a fixed quantity of tokens are allocated over a given time frame to the stakeholders, each association of information to a token decreasing the available quantity.

According to a variant of the latter, a fixed quantity of tokens is allocated over a given time frame to each stakeholder individually.

According to an embodiment the allocated tokens are automatically destroyed after a given time past their allocation if they are not associated.

Allocating a fixed number of tokens, along with the regulation of their association and trade through smart contracts, enables an authority, whether at a state level or at a community level to implement environmental policies and to provide incentives for virtuous consumption or for resource savings.

### BRIEF DESCRIPTION OF THE DRAWINGS

The invention is disclosed hereafter according to one of its embodiments, in no way limiting, and in reference to FIGS. 1 and 2 wherein:

FIG. 1 shows schematically the components of the system, and

FIG. 2 sketches how the system of the invention may be advantageously used to create a marketplace and investment incentive.

### DETAILED DESCRIPTION OF THE EMBODIMENTS

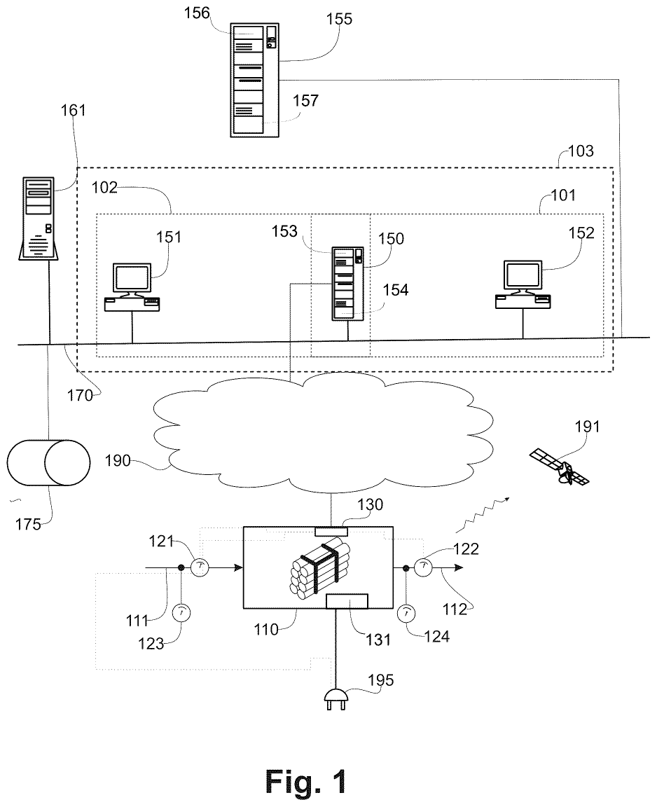

FIG. 1, according to an exemplary embodiment, the elementary components of the system of the invention comprises a water treatment station (110). An incoming stream (111) of water enters the station and an outgoing stream (112) of water is leaving the station after being treated.

The incoming stream (111) may come from a pumping in a natural resource like an aquifer or may be the output stream of another water treatment device, as for instance, when the water treatment station (110) performs a pre-treatment or purification of municipal water in order to make it appropriate for a specific industrial process.

The outgoing stream (112) may be discharged in the environment or may be the incoming stream of a further treatment performed by another water treatment station.

As it can be understood from the above, the water treatment station may be the unique link of a chain or may be a link in a much wider chain of water treatments, connected in series or in parallel or combination thereof, the length of this chain being dependent upon the scale of observation.

The water treatment station (110) may be of a fixed type or may be a mobile device, as for instance, it may be set in a trailer or on a truck and be moved from one location to another to perform a specific treatment.

Once again, in each location, the water treatment station may be considered alone or may be inserted in a wider treatment chain.

The water treatment station (110) is geolocated through a satellite (191) positioning, like the GPS, by way of a cell phone network, or any other type of beacon known from the prior art.

The water treatment station is connected in its location to a power source (195). Such a power source may be electricity from the grid, energy provided by any other source like solar panels, a generator, a battery or a fuel cell without this list being exhaustive.

Depending on the nature of this power source, the location of the water treatment station and the date, the energy supplied through this power source has a given carbon footprint, that may vary over time.

An input sensor (121) measures the incoming flow of water to be treated in the water treatment station.

An output sensor (122) measures the outgoing flow of treated water.

According to an exemplary embodiment, the water treatment station comprises one or more additional sensors known as quality or water-quality sensors (123, 124) measuring in the incoming stream and/or in the outgoing stream, any of the information comprising: temperature, Ph, Calcium content, Nitrates content, Chlorine content, heavy metal content, turbidity and Total Suspended Solids, Total Dissolved Solids, Biological Oxygen Demand, Chemical Oxygen Demand, Specific molecules such as arsenic or polyfluoroalkyl substances (PFAS), and microplastic content.

Or any combination thereof, the information issued by each sensor (121, 122, 123, 124) is transmitted via a wired or wireless connection, or combination thereof, to a communication module (130).

According to an exemplary embodiment, the water-quality sensor (123, 124) comprises a multi-parameter probe configure to measure at least one of: a turbidity sensor, pH sensor, conductivity sensor, dissolved-oxygen sensor, oxidation-reduction potential sensor, calcium sensor, nitrate sensor, electrochemical sensor, total suspended solids sensor, optical sensor, electrical impedance sensor and residual-chlorine sensor.

To this end, the water treatment station (110) comprises a communication module (130) gathering the various information, including the information issued by each sensor, the power consumption, the geolocation, and, according to an exemplary embodiment, sends them through a network (190) to a computer (150).

According to an exemplary embodiment, the water treatment station (110) comprises a least one electronically controllable actuator (131) configured to adjust an operating parameter of the water treatment station (110). According to exemplary embodiment, the electronically controllable actuator (131) comprises a valve actuator, pump actuator, chemical-dosing actuator, a variable-speed pump, or aeration actuator configured to physically modify water-treatment conditions. The actuator-control value specifies a continuous-valued adjustment rather than a binary on/off command.

The computer (150, 155) comprises a non-transitory memory (154, 157), a processor (153,156) and hosts computer programs. The computer (150, 151, 152, 155, 161) is connected as a terminal to a blockchain (170).

A blockchain sets a relation through one or more networks between a plurality of terminals (150, 151, 152) for the purpose of performing peer-to-peer transactions between those terminals.

The blockchain technology is known from the prior art and will not be described in detail.

In a nutshell, for a blockchain to work it needs a tamper-proof ledger (175), which can be a database or non-transitory memory recording the transactions as blocks and stacking (chaining) the blocks on one another so that one block cannot be tampered unless the whole chain is modified, a consensus mechanism that proves a legit transaction between two terminals, and consensus programs implementing the consensus mechanism and the writing in the ledger.

A blockchain is decentralized by nature and does not require a central server. Therefore, it can grow to any size, and an image of the blockchain comprising the stack of transactions, is replicated on each terminal, so that the system is robust and may be rebuilt even after a major outage, provided that at least one terminal is still existing.

According to exemplary embodiment, the blockchain-based authorization subsystem (103) comprises a plurality of user-operated terminals or computers (150, 151, 152), a plurality of digital tokens circulating in the blockchain (170), a distributed ledger, and a consensus program. The distributed ledger, stored in the non-transitory memory or database (175), records peer-to-peer transactions between the terminals (150, 151, 152). The plurality of the processors (153) of the plurality of user-operated terminals (150, 151, 152) executes the consensus program to validate the peer-to-peer transactions and append the validated transactions to the distributed ledger.

According to an exemplary embodiment, the consensus program comprises a proof-of-authority, proof-of-stake, or Byzantine-fault-tolerant consensus mechanism executed by the plurality of processors (153) of the plurality of user-operated terminals (150, 151, 152) to provide tamper-resistant validation.

According to an exemplary embodiment, the consensus program implements a proof-of-authority consensus mechanism executed by authenticated processors associated with the user-operated terminals (150, 151, 152).

According to an exemplary embodiment, the remote computer (155) comprises at least one processor (156) and a non-transitory memory (157) storing instructions. The execution of the instructions stored in the non-transitory memory (157) causes the processor (156) of the remote computer (155) to receive over the communications network (190) via the network interface (130), the input-flow information, the output-flow information, and the quality information from the water treatment station (110). The processor (156) of the remote computer (155) computes, using a control algorithm, at least one actuator-control value for the water treatment station based on the input-flow information, the output-flow information, and the quality information. The processor (156) generates a control-authorization transaction comprising at least one actuator-control value and a quantity of the digital tokens representing a quantified operational performance of the water treatment station (110) during a preceding treatment interval. The processor (156) submits the control-authorization transaction to the blockchain-based authorization subsystem (103) for validation and recording in the distributed ledger. In response to validation of the control-authorization transaction by the consensus program, the processor (156) transmits a control signal to the water treatment station (110) to adjust at least one electronically controllable actuator (131) of the water treatment station (110) according to the actuator control value.

According to an exemplary embodiment, a non-transitory computer-readable medium stores instructions executable by at least one processor (156) of the remote computer (155). The execution of these instructions causes the processor (156) to perform the method described herein for secure and autonomous control of the water treatment station (110).

According to an exemplary embodiment, the control signal to the water-treatment station (110) is encrypted using a session-specific symmetric key generated after validation of the control-authorization transaction.

According to an exemplary embodiment, the validation of the control-authorization transaction by the consensus program forms a machine-enforced, tamper-resistant authorization layer interposed between the control algorithm and the electronically controllable actuator (131), such that actuator adjustments are executable only upon successful blockchain validation, thereby providing a technical improvement in cybersecurity, operational reliability, and traceability of automated water-treatment control loops.

The consensus program executed by a plurality of processors (153) of the plurality of user-operated terminals (150, 151, 152) executes a validation procedure on the control-authorization transaction received from the remote computer (155). According to an exemplary embodiment, the validation procedure comprises cryptographically verifying the integrity of the control-authorization transaction, confirming token-based authorization conditions associated with the actuator-control value, and appending the validated control-authorization transaction to the distributed ledger.

According to an exemplary embodiment, a machine-implemented, tamper-resistant authorization layer interposed between the control algorithm and the electronically controllable actuator is enforced through the blockchain-based validation procedure. The enforcement through the blockchain-based validation procedure prevents execution of actuator adjustments lacking validated authorization, improves cybersecurity by eliminating single-point-of-failure control pathways, increases operational reliability through consensus-based gating of actuator commands, and provides immutable traceability of control-loop decisions within the distributed ledger.

According to an exemplary embodiment, the consensus program rejects control-authorization transactions that exceed a predefined rate-of-change threshold for the actuator-control value, thereby preventing abrupt or unsafe actuator movements.

According to an exemplary embodiment, the remote computer (155) retries submission of the control-authorization transaction upon detection of a failed or incomplete consensus cycle.

According to an exemplary embodiment, the control algorithm executed by the remote computer (155) comprises a predictive model configured to estimate a future water-quality parameter based on historical sensor data, and wherein the actuator-control value is computed to preemptively correct a predicted deviation from a regulatory threshold.

According to an exemplary embodiment, the control algorithm computes the actuator-control value by applying a predictive model trained on historical flow-rate and water-quality data to forecast a future operating condition of the water-treatment station (110).

According to an exemplary embodiment, the actuator-control value comprises a multi-parameter control vector including at least one of: flow-rate adjustment, chemical-dosing rate, aeration intensity, or filtration-cycle duration.

According to an exemplary embodiment, the blockchain subsystem (103) rejects control transactions that fail validation, thereby preventing unauthorized actuator adjustments and improving cybersecurity of the water-treatment station (110).

According to an exemplary embodiment, the distributed ledger stores a chronological sequence of validated control transactions, enabling traceability of actuator adjustments for regulatory compliance and operational auditing.

According to an exemplary embodiment and as implemented by the system of the invention, a transaction between terminals (150, 151, 152) is performed through tokens, preferably digital tokens.

Digital tokens are virtual entities circulating in the blockchain through transactions. A well-known example of such an entity is BITCOIN® although blockchains are in no way limited to cryptocurrencies and to buy and sell transactions.

According to an exemplary embodiment, the digital tokens are algorithmically minted or burned based on a performance metric comprising at least one of: energy consumption per unit of treated water, deviation from a target water-quality parameter, and hydraulic efficiency of the water treatment station (110).

According to an exemplary embodiment, the quantity of digital tokens included in the control-authorization transaction is computed based on at least one of: energy consumption, treatment efficiency, contaminant-removal rate, or compliance with regulatory water-quality thresholds.

According to an exemplary embodiment, the remote computer (155) adjusts a token-issuance rate based on a rolling average of water-treatment performance metrics.

According to an exemplary embodiment, the digital tokens are non-transferable performance tokens usable exclusively for authorizing actuator-control values

The terms and conditions of a transaction in a blockchain are defined by computer programs also known as a smart contract.

A smart contract triggers a transaction upon the occurrence of an event, such an event being internal to the blockchain or taking place outside of the blockchain, but the information of its occurrence being input in the blockchain.

Such a transaction may be an exchange of tokens between a debtor and a creditor, a destruction or burning of tokens, the substitution of one kind of token by another kind of token as described hereafter, or the creation or minting of tokens.

As mentioned in the case of the ledger stored in non-transitory memory or database (175), once implemented, the smart contract is tamper-proof, cannot be abused and cannot be modified unless it is coded accordingly and when the run of another smart contract enables such an amendment.

As a consequence, a specific kind of transaction, not involving tokens, consists in an amendment of the terms and conditions of an existing smart contract, in the limit of the coded capabilities of such an amendment.

Like the ledger, the smart contracts are not stored and executed from a central server but are replicated on each terminal of the blockchain, and therefore cannot be easily tampered with, for instance through a cyberattack; and are tamper-proof from a practical point of view.

The corpus of smart contracts in a blockchain defines a law ruling the transactions in such a blockchain and is sometimes referred to as “lex cryptographica”.

According to an exemplary embodiment, the system comprises a specific terminal or remote computer (155) gathering and centralizing initial transactions with one or more water treatment stations (110) and their associated computers (150), such specific terminal or remote computer (155) is thus a supervising terminal of the water treatment system.

Turning back to FIG. 1, the specific programs hosted by the computer (150) and known as smart contracts, associate a given number and a kind of tokens with the information supplied to the computer by the communication module (130).

Such an association is performed through a transaction and according to a variety of embodiments may be made through a debit and credit mechanism, through the creation of tokens, through the destruction of tokens from an initial stock, or through the substitution of tokens of one kind by another kind.

We give some nonlimiting examples hereafter but the person skilled in the art understands that the principles may applied to a large variety of cases.

As a for instance, the supervising terminal (155) owns a batch of tokens, initially acquired through investors, and sends (credits) a given number of tokens to the computer (150) depending on the information supplied and the smart contract.

Beside the computer (150) shown connected to the water treatment station (110) the other terminals (151, 152) are connected to other water treatment stations implemented by stakeholders of the overall water consumption and treatment chain.

As already mentioned, the terms “water treatment” shall be understood in a broad sense and are actually “stations” through which a water stream is flowing.

As a for instance, an end user consuming tap water and rejecting it in its backyard and in the sewer is a “water treatment station”. Therefore, the blockchain connects stakeholders of a physical water treatment system the extent of which is in theory limitless but may be organized in cells.

In this exemplary embodiment, a cell (101, 102) may gather a plurality of stakeholders represented by their terminals (150, 152) on the blockchain.

In a given cell (101, 102), which may correspond to the stakeholders of a specific community, the relationships/transactions between these stakeholders are defined by a combination of smart contracts some of them affecting only or having specific terms and conditions for the stakeholders of this very cell, and others affecting the entire blockchain.

According to the exemplary embodiment depicted in FIG. 1, different cells (101, 102) may include other stakeholders represented by their terminals (150, 151). Therefore, two cells may have some stakeholders in common, and such stakeholders may be ruled by a plurality of different lex cryptographica.

As it can be understood, the rules pertaining to a small cell may be more detailed and specific than the rules defining the relationship between cells.

In addition, a blockchain-based authorization subsystem (103) or supercell (103) gathering a plurality of subcells (101, 102) may be defined according to geographical or other considerations. Consequently, the whole water network, for example at a country level, may be represented in a virtual space by a blockchain organized in interconnected cells and supercells, with regulations, some of them being locals and others spreading over the whole network.

The transactions, between cells or supercells are ruled by smart contracts defined at the appropriate cell level.

Each terminal is identified by a unique identifier and a single or a plurality of cells memberships, each cell is defined by an identifier and a single or a plurality of supercells memberships and so on.

According to a specific embodiment another kind of terminal or remote computer (161) may be connected to the blockchain (170). Such a terminal (161) is not directly part of the water treatment system and is used to connect the blockchain to “out of the water network” type of transaction. As an exemplary embodiment the aforesaid terminal may allow a financial service provider to acquire or exchange tokens.

According to an embodiment, the token circulating in the blockchain and involved in the transactions ruled by the smart contracts are of two types.

A first type is called a utility token. Such a token is an intangible asset, and to some extent, can be compared to a cryptocurrency like BITCOIN®, ETHEREUM®, SOLANA® and the like.

The other type is called a Nonfungible Token or NFT. Although a token is intangible in nature, an NFT may be associated with an identified asset or treatment. By identified, it shall be understood any or all of: a geographical location, a specific type of water treatment, a treatment date, a specific delivered water quality (assessed by the sensors), and a specific type or a specific water treatment installation.

The list being nonlimiting.

As an example of the way those tokens may be used, an investor wishing to invest in a water treatment system, the aforesaid investor being environmentally conscious and wishing to favour high quality water treatments, or low carbon footprint treatments, or treatments of water contaminated by heavy metals or in a specific geographic area, will purchase utility tokens assorted with its requirements.

By purchasing these tokens, the investor provides funds for implementing water treatment installations, said tokens being not specific to a single material installation.

According to his exemplary embodiment, although the investor expressed requirements associated with its investment, those requirements are not attached to the token he purchases, which are “requirement blind” but defined in a smart contract.

According to the requirements of the investor, when either new or existing installations fulfilling those requirements are run, the associated tokens are of the NFT type, meaning they are specifically associated with any or all of a date, a treated water quality, a geographical location, a carbon footprint and so on.

The NFTs fulfilling the requirements of the investor, will be substituted to the utility tokens owned by the aforesaid investor through one or more smart contracts and associated transactions, said now generic utility tokens being once again available for sale to another investor with other requirements.

It shall be understood that the NFTs substituted to the utility tokens may come from a plurality of cells or supercells provided that they fulfil the requirements of the investor.

Actually, the investor invests in a treatment capability, as a share of the water treatment system expressed as an invested asset, a quantity of treated water fulfilling its requirements and not necessarily a quantity of water that he will consume itself or even that will be consumed in its living area, The investor may even be living in another country.

On the other hand, the treated water fulfilling the requirements and generating the NFTs is also invoiced to an individual or to a community.

From an overall point of view, as the scarcity of quality water is worsening with time and as the regulations are tightening, the cost of such a treatment increases. This cost may be embedded in an end-user subscription agreement as a cost-of-living adjustment.

As a result, an investor purchasing a large quantity of utility tokens with tight requirements will likely pay less for those utility tokens than the total lifetime revenue from the underlying asset. Therefore, the token has inherent value beyond its face or initial value, and there is a profit that may be shared between the investor and other stakeholders like the company operating the water treatment installation.

These profits may be paid to the investor in the form of additional utility tokens, of another cryptocurrency or even in fiduciary currency.

This way, the stakeholders of a water treatment system may raise funds in order to continuously improve the aforesaid system.

In other words, in this exemplary embodiment, the utility tokens purchased by the investor that correspond to an investment in a water treatment system, generates a revenue stream to its profit, depending on the quantity and the quality of water treated.

As for the requirements, those may be proposed by a management authority of the water treatment system in predefined bundles corresponding to different levels of investments, revenue streams and accordingly to different performances in water treatment, each bundle is associated to a predefined smart contract implemented in blockchain.

Since the utility tokens purchased by the investor are not connected to any specific installation, but actually to the performance of the whole network covered by the blockchain, the tokens may be freely transferred to another party without affecting the ownership of the equipment they finance.

In fact, each token includes the entirety of all future profit shares that an investor has a pro rata right to.

The above example is not the only way of using the system of the invention.

As another exemplary embodiment that is fully compatible with the aforementioned example, the system of the invention may be used to manage a water resource among stakeholders.

To this end, as for instance, a ruling authority allocates, through the supervising terminal (155), a fixed amount of tokens to the stakeholder of one or more cells.

This fixed number of tokens may be allocated for a given time frame, meaning that those tokens are, as an example, automatically destroyed past a given time after their allocation.

Through a specific transaction the authority implements rules among the stakeholders through the amendment of smart contracts. Those rules may set the destruction time frame of the allocated tokens, or the number of tokens consumed or substituted depending on the parameters associated with the water treatment tokens.

If the initially allocated tokens are representing the yearly quantity of water a stakeholder of a water system is allowed to pump in a resource, the stakeholder water consumption may be deducted at a pace depending on the quality of the water treatment implemented by the stakeholder or stakeholders belonging to the same cell.

As a for instance, if the post treatment provides water of high quality, which is measured in real time by the sensors, one gallon of consumed water results in the destruction of one allocated token.

However, if the post-treatment is of poor quality or if the water is not post-treated before being released in the environment, one gallon of consumed water results in the destruction of 2 or 1.5 initially allocated tokens.

All these transactions are performed automatically, in almost real time through smart contracts.

Once a stakeholder or a group of stakeholders do no longer own allocated tokens, it shall acquire such tokens from another stakeholder belonging to the same cell or to neighbouring cells.

To this end the system of the invention comprises, at the blockchain level, a digital auction mechanism, where prudent stakeholders saving water and/or implementing high end water treatment may be rewarded by conceding their saved rights to others.

The person skilled in the art understands that combining such auction mechanism with the fundraising mechanism may help a community to implement cutting edge water treatment and water management service by financing these services on the fly.

Additionally, the system of the invention comprises a specific computer program, i.e., smart contract, that is intended for conflict resolution. Such a program may be used to amend or to stop the performance of smart contracts that have been coded accordingly and may be triggered and implemented through a specific terminal (160) by an arbitration authority.

The exemplary embodiment disclosed herein show that the invention achieves its intended aims by providing the users of the system and the method of the invention strong incentive for a continuous improvement and lean management of a water treatment system.

It shall be understood that each token may be connected, in real time to a small quantity of treated water, namely a gallon or a quart, such a granularity being enabled by the automation provided by tokens and smart contracts. Alternatively, the token in an NFT expression may represent a very large amount of treated water, with the inherent NFT fractional capability representing small quantities.

In particular, the system and the method of the invention allow micro-parts of larger investments and micro-parts of larger payments, in a capital-intensive domain, those financial streams being strongly geared to the performance of a water treatment system, by automated all these transactions.

Such a micro financing, solving a macro challenge would not be possible with conventional means, i.e., without the blockchain, as dividend account updates would be required in a back office, with the usual errors, customer service problems, etc., and basically the profits would be absorbed by the required accounting and management structure.

Without the blockchain and the advantages provided by tokens and smart contracts such a micro-investment would be difficult to implement beyond the local level.

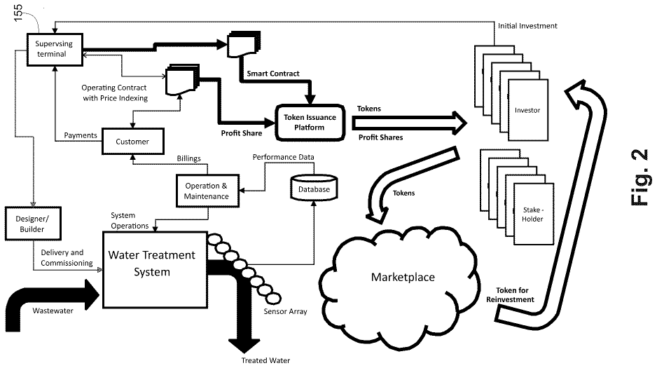

FIG. 2 illustrates the system of the invention advantageously implemented to set up a marketplace where NFTs or tokens represent water treatment revenues, which due to water rate inflation, desertification and dollar inflation, predicated to increase in value, creating a basis for secondary market pricing, leverage, options and other financial market devices.

According to this exemplary embodiment, the water treatment system is financed by an initial investment that translate into tokens bought upfront by investor, as for instance in an ICO: “initial coin offering”’.

The initial number of issued tokens depends on the implementation cost of the water treatment system as well as on the expected volume of water to be treated during a given amortization time frame.

In an exemplary embodiment, NFTs are generated according to the volume and quality of water treated and the conditions defined in smart contracts.

Turning back to FIG. 1, in such embodiment, NFTs are created through a transaction on the blockchain between the computer (150) and the supervising terminal (155).

Such NFTs may further be transferred to investors and stakeholder associated with a value.

Investors and stakeholders may place those NFTs on the marketplace.

As a consequence, NFTs may characterize the contribution of their holder to the investment in the water treatment systems and the consequent stream of payments as for instance, revenue shares or dividends.

The claimed invention, having been described, will make apparent to those skilled in the art that the same may be varied in many ways without departing from the spirit and scope of the invention. Any and all such modifications are intended to be included within the scope of the following claims.

1. A computer-implemented water treatment control system, comprising:
a water treatment station comprising a water input, a water output, at least one electronically controllable actuator configured to adjust an operating parameter of the water treatment station, and an energy source supplying power to the actuator;
an input flow sensor configured to measure an input flow rate at the water input and to generate input-flow information;
an output flow sensor configured to measure an output flow rate at the water output and to generate output-flow information;
a water-quality sensor configured to measure at least one water-quality parameter at the water output and to generate quality information;
a network interface configured to transmit the input-flow information, the output-flow information, and the quality information to a remote computer over a communications network;
a blockchain-based authorization subsystem comprising:
a plurality of user-operated terminals;
a plurality of digital tokens;
a distributed ledger stored in non-transitory memory and configured to record peer-to-peer transactions between the terminals; and
a consensus program executed by a plurality of processors to validate the peer-to-peer transactions and append validated transactions to the distributed ledger;
the remote computer comprising at least one processor and a non-transitory memory storing instructions which, when executed, cause said at least one processor to:
receive, via the network interface, the input-flow information, the output-flow information, and the quality information;
compute, using a control algorithm, at least one actuator-control value for the water treatment station based on the input-flow information, the output-flow information, and the quality information;
generate a control-authorization transaction comprising said at least one actuator-control value and a quantity of the digital tokens representing a quantified operational performance of the water treatment station during a preceding treatment interval;
submit the control-authorization transaction to the blockchain-based authorization subsystem for validation and recording in the distributed ledger; and
in response to validation of the control-authorization transaction by the consensus program, transmit a control signal to the water treatment station to adjust said at least one electronically controllable actuator according to the actuator control value; and
wherein validation of the control-authorization transaction by the consensus program forms a machine-enforced, tamper-resistant authorization layer interposed between the control algorithm and said at least one electronically controllable actuator, such that actuator adjustments are executable only upon successful blockchain validation, thereby providing a technical improvement in cybersecurity, operational reliability, and traceability of automated water-treatment control loops.

2. The system of claim 1, wherein said at least one electronically controllable actuator comprises a valve actuator, pump actuator, chemical-dosing actuator, a variable-speed pump, or aeration actuator configured to physically modify water-treatment conditions; and wherein the actuator-control value specifies a continuous-valued adjustment rather than a binary on/off command.

3. The system of claim 1, wherein the control algorithm executed by the remote computer comprises a predictive model configured to estimate a future water-quality parameter based on historical sensor data, and wherein the actuator-control value is computed to preemptively correct a predicted deviation from a regulatory threshold.

4. The system of claim 1, wherein the blockchain subsystem is further configured to reject control transactions that fail validation, thereby preventing unauthorized actuator adjustments and improving cybersecurity of the water treatment station.

5. The system of claim 1, wherein the distributed ledger stores a chronological sequence of validated control transactions, enabling traceability of actuator adjustments for regulatory compliance and operational auditing.

6. The system of claim 1, wherein the consensus program comprises a proof-of-authority, proof-of-stake, or Byzantine-fault-tolerant consensus mechanism executed by the plurality of processors to provide tamper-resistant validation.

7. The system of claim 1, wherein the water-quality sensor comprises a multi-parameter probe configure to measure at least one of: a turbidity sensor, pH sensor, conductivity sensor, dissolved-oxygen sensor, oxidation-reduction potential sensor, calcium sensor, nitrate sensor, electrochemical sensor, total suspended solids sensor, optical sensor, electrical impedance sensor and residual-chlorine sensor.

8. The system of claim 1, wherein the digital tokens are algorithmically minted or burned based on a performance metric comprising at least one of: energy consumption per unit of treated water, deviation from a target water-quality parameter, and hydraulic efficiency of the water treatment station.

9. The system of claim 1, wherein the consensus program rejects control-authorization transactions that exceed a predefined rate-of-change threshold for the actuator-control value, thereby preventing abrupt or unsafe actuator movements.

10. A computer-implemented method for secure and autonomous control of a water treatment station, the method executed by at least one processor of a remote computer and comprising:
receiving, via a communications network, input-flow information from an input flow sensor, output-flow information from an output-flow sensor, and quality information from a water-quality sensor of a water treatment station, the water treatment station comprising at least one electronically controllable actuator;
processing, by the remote computer, the input-flow information, the output-flow information, and the quality information using a control algorithm to compute at least one actuator-control value configured to adjust an operating parameter of the water treatment station;
generating, by the remote computer, a control-authorization transaction comprising the actuator-control value and a quantity of digital tokens representing a quantified operational performance of the water treatment station during a preceding treatment interval;
submitting the control-authorization transaction to a blockchain-based authorization subsystem comprising a plurality of user-operated terminals, a plurality of digital tokens, a distributed ledger stored in non-transitory memory, and a consensus program executed by a plurality of processors;
executing, by the consensus program, a validation procedure comprising:
cryptographically verifying the integrity of the control-authorization transaction;
confirming token-based authorization conditions associated with the actuator-control value; and
appending the validated control-authorization transaction to the distributed ledger;
transmitting, by the remote computer and only in response to successful validation of the control-authorization transaction, a control signal to the water treatment station to adjust the electronically controllable actuator according to the actuator-control value; and
enforcing, through the blockchain-based validation procedure, a machine-implemented, tamper-resistant authorization layer interposed between the control algorithm and the electronically controllable actuator, thereby:
preventing execution of actuator adjustments lacking validated authorization,
improving cybersecurity by eliminating single-point-of-failure control pathways,
increasing operational reliability through consensus-based gating of actuator commands, and
providing immutable traceability of control-loop decisions within the distributed ledger.

11. The method of claim 10, wherein computing the actuator-control value further comprises applying a predictive model trained on historical flow-rate and water-quality data to forecast a future operating condition of the water treatment station.

12. The method of claim 10, wherein the water-quality sensor comprises a multi-parameter probe configure to measure at least one of: a turbidity sensor, pH sensor, conductivity sensor, dissolved-oxygen sensor, oxidation-reduction potential sensor, calcium sensor, nitrate sensor, electrochemical sensor, total suspended solids sensor, optical sensor, electrical impedance sensor and residual-chlorine sensor.

13. The method of claim 10, wherein the consensus program implements a proof-of-authority consensus mechanism executed by authenticated processors associated with the user-operated terminals.

14. The method of claim 10, wherein transmitting the control signal to the water treatment station further comprises encrypting the control signal using a session-specific symmetric key generated after validation of the control-authorization transaction.

15. The method of claim 10, wherein the quantity of digital tokens included in the control-authorization transaction is computed based on at least one of: energy consumption, treatment efficiency, contaminant-removal rate, or compliance with regulatory water-quality thresholds.

16. The method of claim 10, wherein the actuator-control value comprises a multi-parameter control vector including at least one of: flow-rate adjustment, chemical-dosing rate, aeration intensity, or filtration-cycle duration.

17. The method of claim 10, wherein the remote computer adjusts a token-issuance rate based on a rolling average of water-treatment performance metrics.

18. The method of claim 10, wherein the digital tokens are non-transferable performance tokens usable exclusively for authorizing actuator-control values.

19. The method of claim 10, wherein the remote computer is configured to retry submission of the control-authorization transaction upon detection of a failed or incomplete consensus cycle.

20. A non-transitory computer-readable medium storing instructions that, when executed by at least one processor of a remote computer, cause the processor to perform the method of claim 10 for secure and autonomous control of a water treatment station.
